(19) United States
(12) Patent Application Publication
(10) Pub. No.: US 2007/0286052 A1
(43) Pub. Date: Dec. 13, 2007

(54) OPTICAL PICKUP DEVICE

(75) Inventors: Kenji Nagatomi, Kaidu-City (JP); Yoichi Tsuchiya, Hashima-City (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 11/759,039

(22) Filed: Jun. 6, 2007

(30) Foreign Application Priority Data
Jun. 12, 2006 (JP) 2006-162195

(51) Int. Cl. G11B 7/00

(52) U.S. Cl. 369/112.02; 369/112.05; 369/112.23

(57) ABSTRACT

A Bragg-grating-based liquid crystal element is disposed on an optical axis of a first objective lens with a tilt angle of more than 45° with respect to the optical axis of the first objective lens. By inputting a laser beam to the Bragg-grating-based liquid crystal element in such a manner that a reflection direction of the light beam by the Bragg-grating-based liquid crystal element is in parallel with a short axis of a shape of the laser beam, the reflected laser beam has a shape whose dimension is elongated in the short axis direction.

### This application claims priority under 35 U.S. C. Section 119 of Japanese Patent Application No. 2006-162195 filed Jun. 12, 2006.

### BACKGROUND OF THE INVENTION

1. Field of the Invention

The present invention relates to an optical pickup device, and more particularly to a compatible optical pickup device provided with two or more objective lenses.

2. Description of the Related Art

It is known that two or more objective lenses are used in an optical pickup device compatible with several kinds of discs having different disc thicknesses. In the compatible optical pickup device, an optical system needs an internal arrangement capable of properly guiding a laser beam toward any one of the objective lenses.

FIG. 12 shows an example of the above arrangement.

Referring to FIG. 12, the reference numeral 1 denotes a semiconductor laser, 2 denotes a collimator lens, 3 denotes a polarization converting element, 4 denotes a polarizing beam splitter, 5 denotes a mirror, 6 denotes a λ/4 plate, 7 denotes a first objective lens, 8 denotes a second objective lens, and 9 denotes an optical detection system.

A laser beam emitted from the semiconductor laser 1 is collimated into parallel beams by the collimator lens 2, and then, the parallel beams have their polarization directions regulated by the polarization converting element 3. When the polarization direction of the laser beam is in a first direction, the laser beam is reflected by the polarizing beam splitter 4 toward the first objective lens 7. When the polarization direction of the laser beam is in a second direction orthogonal to the first direction, the laser beam is transmitted through the polarizing beam splitter 4, and is incident onto the second objective lens 8 via the mirror 5. In this way, the objective lens onto which the laser beam is allowed to be inputted is switched over by the polarization converting element 3 by switching over the polarization direction of the laser beam between the first direction and the second direction.

In addition to the above, use of a Bragg-grating-based liquid crystal element is known to distribute laser beams between two objective lenses.

In the conventional example shown in FIG. 12, generally, the polarizing beam splitter 4 and the mirror 5 have reflective surfaces thereof inclined with an angle of 45° with respect to optical axes of the objective lenses 7 and 8. In this arrangement, the shape of the laser beam immediately before being inputted to the polarizing beam splitter 4, and the shape of the laser beam after being reflected by the polarizing beam splitter 4 or the mirror 5 are substantially identical to each other. Accordingly, in the case where a laser beam is inputted to an intended one of the objective lenses 7 and 8 with a sufficiently large effective diameter, it is required to secure a laser beam with a sufficiently large shape immediately before being inputted to the polarizing beam splitter 4. An unduly increase of the dimension of the beam shape may increase the dimension L in FIG. 12, which may resultantly increase the dimension of the optical system in a thickness direction (optical axis direction of the objective lens).

### SUMMARY OF THE INVENTION

An optical pickup device according to an aspect of the invention includes: a first objective lens; a Bragg-grating-based liquid crystal element disposed on an optical axis of the first objective lens with a tilt angle of more than 45° with respect to the optical axis of the first objective lens, the Bragg-grating-based liquid crystal element being so configured that a laser beam is inputted in a first direction perpendicular to the optical axis of the first objective lens, and that the laser beam is transmitted or reflected in a second direction parallel to the optical axis of the first objective lens depending on application and non-application of a voltage; a second objective lens disposed away from the first objective lens in the first direction, and having an optical axis parallel to the optical axis of the first objective lens; and an optical device for guiding the laser beam transmitted through the Bragg-grating-based liquid crystal element to the second objective lens, wherein a short axis direction of a shape of the laser beam to be inputted to the Bragg-grating-based liquid crystal element is parallel to the second direction.

The Bragg-grating-based liquid crystal element of the claimed invention corresponds to a switching mirror 104 of an embodiment of the invention. The optical path regulating element of the claimed invention corresponds to dichroic prisms 126 and 127 of the embodiment of the invention.

The below-mentioned embodiment, however, does not specifically limit the invention.

### BRIEF DESCRIPTION OF THE DRAWINGS

These and other objects and novel features of the invention will become more apparent upon reading the following detailed description of the preferred embodiments along with the accompanying drawings.

FIGS. 1A and 1B are diagrams showing an arrangement of an optical pickup device according to an embodying the present invention.

FIGS. 2A and 2B are diagrams for describing an arrangement of a switching mirror embodying the present invention.

FIGS. 3A and 3B are diagrams for describing an operation of the switching mirror embodying the present invention.

FIGS. 4A and 4B are diagrams for describing an operation of the switching mirror embodying the present invention.

FIGS. 5A, 5B, and 5C are diagrams for describing a beam shaping effect of the switching mirror embodying the invention.

FIG. 6 is a diagram showing a modification of the optical pickup device embodying the present invention.

FIG. 7 is a diagram showing another modification of the optical pickup device embodying the present invention.

FIG. 8 a diagram showing another modification of the optical pickup device embodying the present invention.

FIG. 9 is a diagram showing another modification of the optical pickup device embodying the present invention.

FIGS. 10A and 10B are diagrams for describing an operation of a switching mirror as a modified embodiment of the present invention.

FIG. 11 is a diagram for describing a modified arrangement of the switching mirror embodying the present invention.

FIG. 12 is a diagram showing a conventional arrangement.

The drawings are provided merely for description of the embodiments, and do not limit the scope of the invention.

### DESCRIPTION OF THE PREFERRED EMBODIMENTS

In the following, an embodiment of the present invention is described referring to the drawings. The embodiment describes an example, in which the invention is applied to an optical pickup device compatible with an HDDVD (High Definition Digital Versatile Disc) of 0.6 mm in disc thickness, and a BD (Blu-ray Disc) of 0.1 mm in disc thickness.

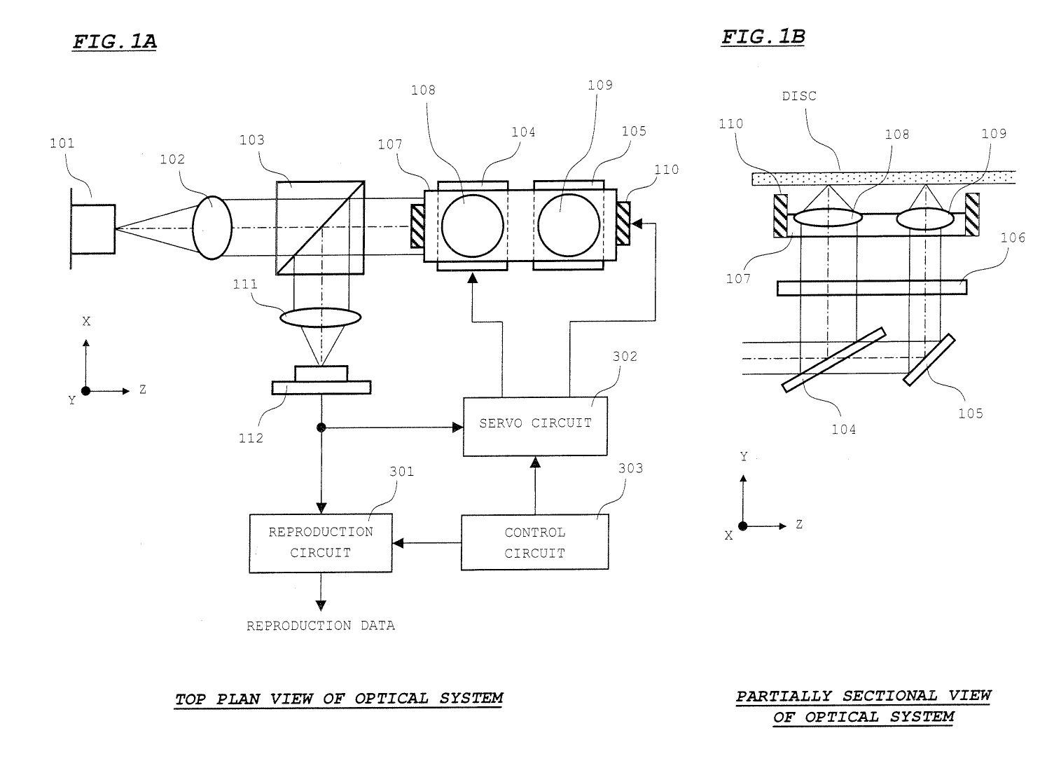

First, an optical system of the optical pickup device shown in FIGS. 1A and 1B according to the embodiment is described. FIG. 1A is a top plan view of the optical system, and FIG. 1B is a side view of an object lens actuator and peripheral parts thereof. FIG. 1A also shows an arrangement of an optical disc device (a reproduction circuits 301, a servo circuit 302, a control circuit 303) for the sake of explanation.

As shown FIGS. 1A and 1B, the optical system of the optical pickup device includes a semiconductor laser 101, a collimator lens 102, a polarizing beam splitter 103, a switching mirror 104, a mirror 105, a λ/4 plate 106, a holder 107, objective lenses 108, 109, an objective lens actuator 110, a condenser lens 111, and a light detector 112.

The semiconductor lens 101 outputs laser beams having a wavelength (about 400 nm) corresponding to blue. The collimator lens 102 collimates the laser beams outputted from the semiconductor laser 101 into parallel beams. The polarizing beam splitter 103 substantially transmits the laser beams coming from the collimator lens 102, and reflects the laser beams coming from the switching mirror 104.

The switching mirror 104 reflects (diffracts) the laser beams from the polarizing beam splitter 103 toward the objective lens 108 when a voltage is not applied from the servo circuit 302, and reflects (diffracts) reflection beams from a disc toward the polarizing beam splitter 103. On the contrary, when a voltage is applied from the servo circuit 302, the switching mirror 104 transmits the laser beams from the polarizing beam splitter 103 to guide the laser beams toward the mirror 105, and transmits the reflection beams from the disc to guide the laser beams toward the polarizing beam splitter 103. The switching mirror 104 is disposed with an inclination of more than 45° (e.g. 60°) with respect to an optical axis of the objective lens 108. The switching mirror 104 will be described later in detail.

The mirror 105 reflects the laser beams transmitted through the switching mirror 104 toward the objective lens 109. The mirror 105 is disposed with an inclination of 45° with respect to an optical axis of the objective lens 109.

The λ/4 plate 106 converts the laser beams coming from the switching mirror 104 or the mirror 105 into a circular polarized beam, and converts the reflection beams from the disc into a linear polarized beam extending in a direction orthogonal to the polarization direction of the laser beam to be inputted to the disc. Thereby, the laser beam reflected on the disc is reflected by the polarizing beam splitter 103.

The holder 107 holds the objective lenses 108 and 109 thereon. The objective lens actuator 110 drives the holder 107 in a focus direction and a tracking direction in accordance with a servo signal from the servo circuit 302. Thereby, the objective lenses 108 and 109 are integrally driven in the focus direction and the tracking direction. The objective lens actuator 110 has a well-known electromagnetic drive mechanism provided with a coil and a magnet. For instance, a coil is mounted on the holder 107, and a magnet is mounted on a holder base.

The objective lens 108 is designed in such a manner that a blue wavelength laser beam can be properly converged on an HDDVD of 0.6 mm in disc thickness. The objective lens 109 is designed in such a manner that the blue wavelength laser beam can be properly converged on a BD of 0.1 mm in disc thickness.

The condenser lens 111 converges the laser beam reflected by the disc on the light detector 112. The light detector 112 has a sensor pattern for outputting a reproduction RF signal, a focus error signal, and a tracking error signal based on an intensity distribution of the received laser beam. Sensor signals from the respective sensors of the light detector 112 are outputted to the reproduction circuit 301 and to the servo circuit 302.

The reproduction circuit 301 obtains the reproduction RF signal by computing the sensor signal outputted from the light detector 112, and generates reproduction data by demodulating the reproduction RF signal.

The servo circuit 302 obtains the tracking error signal and the focus error signal by computing the sensor signal outputted from the light detector 112, generates a tracking servo signal and a focus servo signal based on the tracking error signal and the focus error signal, and outputs the tracking servo signal and the focus servo signal to the objective lens actuator 110. Further, the servo circuit 302 applies a drive voltage to the switching mirror 104 in response to a command from the control circuit 303. The control circuit 303 controls the respective parts in accordance with an input command or the like by way of a key input section (not shown).

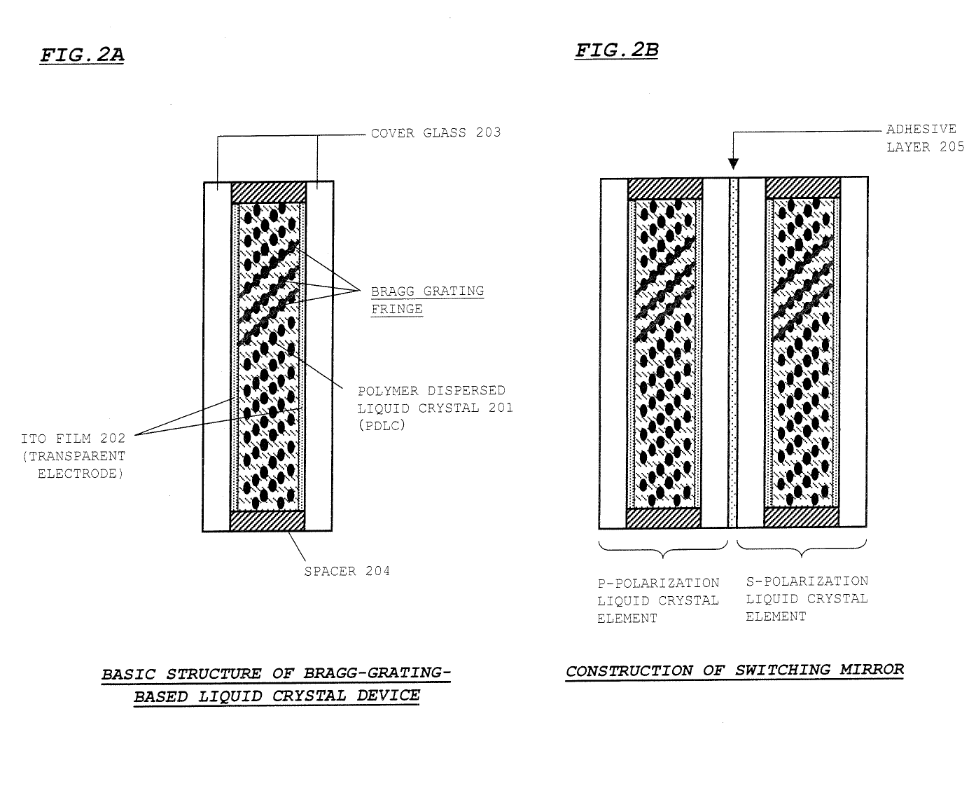

FIGS. 2A and 2B are diagrams showing the details of the switching mirror 104.

First, referring to FIG. 2A, a Bragg-grating-based liquid crystal element (electrically switchable Bragg grating or ESBG), which is a constituent element of the switching mirror 104, is described. FIG. 2A is a cross-sectional side view of the Bragg-grating-based liquid crystal deice (ESBG).

The Bragg-grating-based liquid crystal element is formed by sealably containing a polymer dispersed liquid crystal 201 in two cover glasses 203, and a spacer 204. ITO films (transparent electrodes) 202 are formed in inner surfaces of the two cover glasses 203, respectively.

A polymer (Bragg grating fringe) having a predetermined pattern is fixedly formed in the polymer dispersed liquid crystal 201. The polymer is fixed in the polymer dispersed crystal 201 by sealably containing a prepolymer including liquid crystals, monomers, cross-linked monomers, and a polymerization initiator in the two cover glasses 203 and the spacer 204, followed by optical interferometry in the prepolymer using two beams of light. When the optical interferometry is performed in the prepolymer using the two beams of light, an interference fringe pattern having bright and dark fringes is formed in the prepolymer. The monomers in the prepolymer having a higher photopolymerization are attracted to a bright area of the interference fringe pattern for polymerization. Thereby, a Bragg grating fringe (volume hologram structure) in accordance with the interference fringe pattern is fixedly formed in the prepolymer. The fixing pattern of the polymer is a pattern for providing a laser beam with a diffraction performance capable of changing the propagating direction of the laser beam by a predetermined angle.

Light with a wavelength to be diffracted by the Bragg grating fringe is used as the light for exposure in the fixing process. In other words, in the embodiment, a blue laser beam of about 400 nm in wavelength is used as the light for exposure.

The refractive index np of the polymer and the refractive index nLC of the liquid crystal are adjusted to satisfy a relation: nLC≠np in a condition that a voltage is not applied to the polymer dispersed liquid crystal 201 by way of the ITO films 202. The liquid crystal is arranged in such a manner that the refractive index thereof is approximate to the refractive index of the polymer, as the voltage is applied to the polymer dispersed liquid crystal 201. The refractive index nLC of the liquid crystal molecules is coincident with the refractive index np of the polymer when a voltage Vd is applied to the polymer dispersed liquid crystal 201.

A refractive index difference is generated between the polymer and the liquid crystal (nLC≠np) in a condition that a voltage is not applied to the polymer dispersed liquid crystal 201. In this condition, a Bragg grating fringe (volume hologram structure) by the polymer is formed in the polymer dispersed liquid crystal 201. As a result, the laser beam incident onto the polymer dispersed liquid crystal 201 is subjected to diffraction by the Bragg grating fringe.

On the other hand, the refractive indexes of the polymer and the liquid crystal are coincident with each other (nLC=np) in a condition that the voltage Vd is applied to the polymer dispersed liquid crystal 201. In this condition, a Bragg grating fringe (volume hologram structure) by the polymer is not formed in the polymer dispersed liquid crystal 201. As a result, the laser beam incident onto the polymer dispersed liquid crystal 201 is transmitted through the polymer dispersed liquid crystal 201 without being subjected to diffraction by the Bragg grating fringe.

In the arrangement of FIG. 2A, if the polarization direction of the laser beam is greatly displaced from a polarization direction (hereinafter, called as “reference polarization direction”) in which a diffraction performance is properly shown in the Bragg grating fringe (volume hologram structure), the diffraction by the Bragg grating fringe may not be properly applied to the laser beam, because the Bragg grating fringe (volume hologram structure) has a high polarization dependency. On the other hand, in the optical system shown in FIGS. 1A and 1B, the polarization direction of the laser beam (hereinafter, called as “incoming laser beam”) to be reflected by the disc and inputted to the switching mirror 104 is displaced from the polarization direction of the laser beam (hereinafter, called as “reflected laser beam”) coming from the polarizing beam splitter 103 to the switching mirror 104 by 90 degrees by the action of the λ/4 plate 106. Accordingly, if the polarization direction of one of the incoming laser beam and the reflected laser beam is coincident with the reference polarization direction of the Bragg grating fringe, it is impossible to provide the other one of the incoming laser beam and the reflected laser beam with the aforementioned diffraction performance.

In view of the above, in the embodiment, as shown in FIG. 2B, a Bragg-grating-based liquid crystal element (a liquid crystal element for P-polarized laser beam, hereinafter, called as “P-polarization liquid crystal element”) for the incoming laser beam, and a Bragg-grating-based liquid crystal element (a liquid crystal element for S-polarized laser beam, hereinafter, called as “S-polarization liquid crystal element”) for the reflected laser beam are individually prepared, and the switching mirror 104 is formed by adhering the two Bragg-grating-based liquid crystal elements via an adhesive layer 205.

The P-polarization liquid crystal element has a feature that the reference polarization direction of the Bragg grating fringe is aligned with the polarization direction of the incoming laser beam (P-polarized laser beam) which has been transmitted through the polarizing beam splitter 103. The S-polarization liquid crystal element has a feature that the reference polarization direction of the Bragg grating fringe is aligned with the polarization direction of the reflected laser beam (S-polarized laser beam) having a polarization surface angularly displaced by 90 degrees by the λ/4 plate 106. The diffraction performances to be applied respectively to the incident laser beam and the reflected laser beam by the P-polarization liquid crystal element and the S-polarization liquid crystal element are identical to each other.

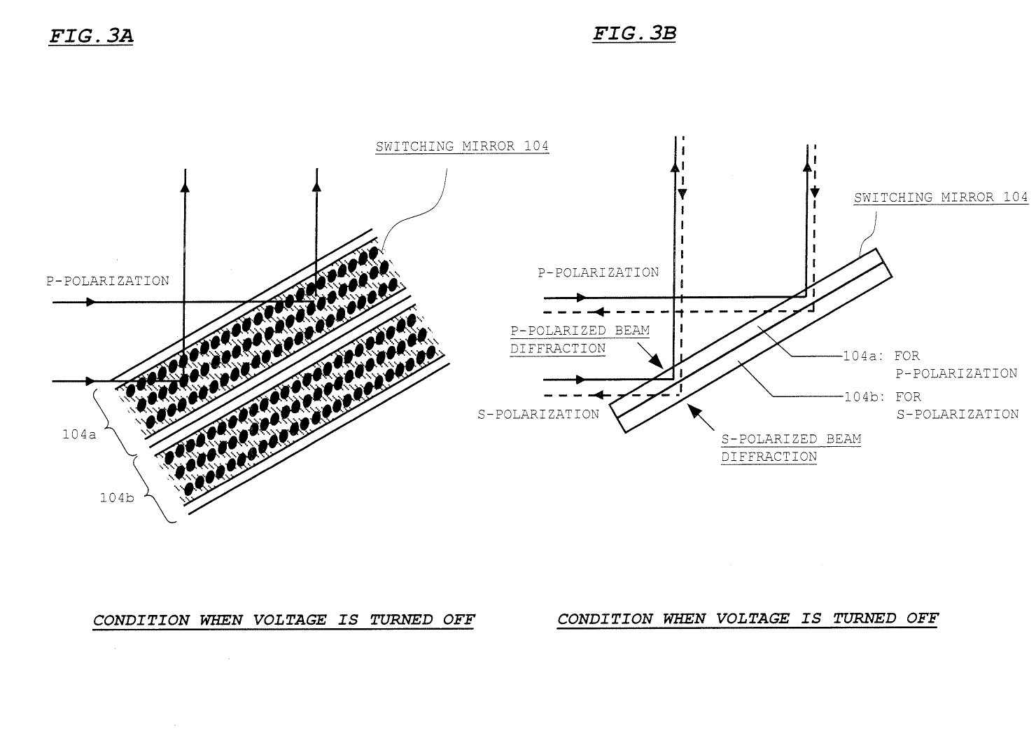

FIGS. 3A and 3B are diagrams showing optical paths of laser beams when a voltage is not applied to the P-polarization liquid crystal element 104a and to the S-polarization liquid crystal element 104b.

As shown in FIG. 3A, the incident laser beam (P-polarized laser beam) transmitted through the polarizing beam splitter 103 has the polarization direction aligned with the reference polarization direction of the P-polarization liquid crystal element 104a. Accordingly, the incident laser beam is diffracted by the P-polarization liquid crystal element 104a, and has its optical path changed in the direction toward the objective lens 108.

On the other hand, the reflected laser beam (S-polarized laser beam) reflected by the disc has the polarization direction angularly displaced with respect to the reference polarization direction of the P-polarization liquid crystal element 104a by 90 degrees. Accordingly, as shown in FIG. 3B, the reflected laser beam is inputted to the S-polarization liquid crystal element 104b without being subjected to diffraction by the P-polarization liquid crystal element 104a. In the input of the reflected laser beam, the reflected laser beam is diffracted by the S-polarization liquid crystal element 104b, and has its optical path changed in the direction toward the polarizing beam splitter 103, because the polarization direction of the reflected laser beam is aligned with the reference polarization direction of the S-polarization liquid crystal element 104b.

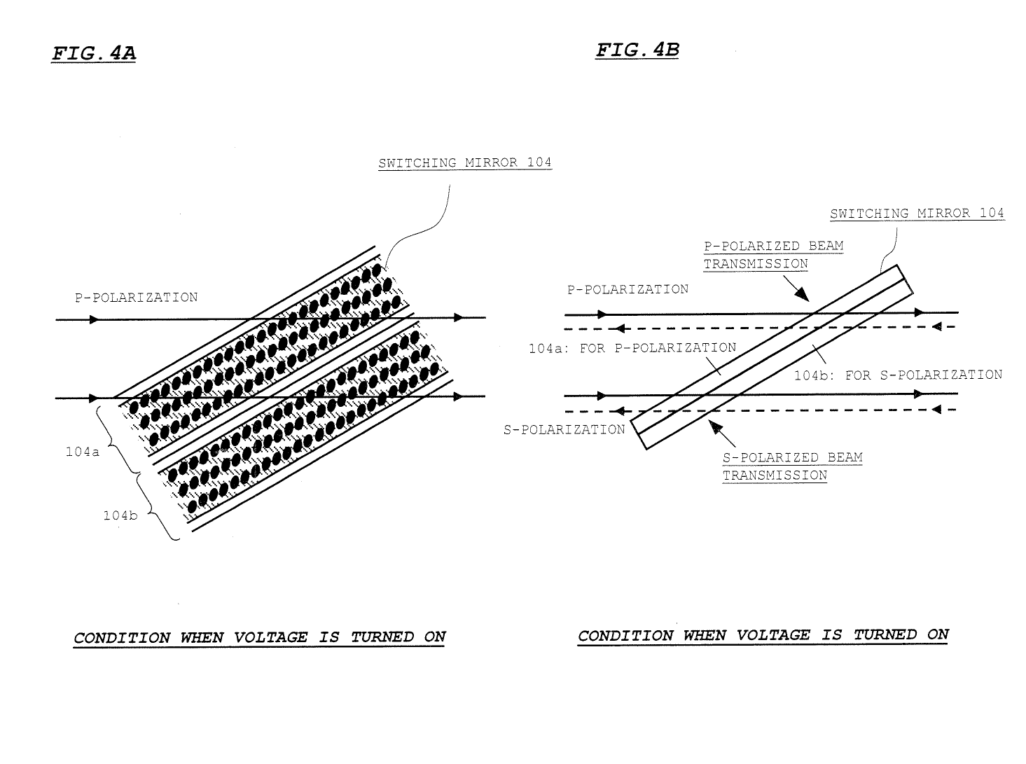

FIGS. 4A and 4B are diagrams showing optical paths of laser beams when the voltage vd is applied to the P-polarization liquid crystal element 104a and the S-polarization liquid crystal element 104b, respectively.

As shown in FIG. 4A, the incident laser beam (P-polarized laser beam) transmitted through the polarizing beam splitter 103 is first inputted to the P-polarization liquid crystal element 104a. In the input of the incident laser beam, a Bragg grating fringe (volume hologram structure) is not formed in the P-polarization liquid crystal element 104a, because the refractive indexes of the polymer and the liquid crystal in the P-polarization liquid crystal element 104a are identical to each other by the application of the voltage Vd. Accordingly, the incident laser beam is transmitted through the P-polarization liquid crystal element 104a without being subjected to diffraction by the P-polarization liquid crystal element 104a.

Then, the incident laser beam is inputted to the S-polarization liquid crystal element 104b. Similarly to the above, the incident laser beam is transmitted through the S-polarization liquid crystal element 104b without being subjected to diffraction by the S-polarization liquid crystal element 104b, because a Bragg grating fringe (volume hologram structure) is not formed in the S-polarization liquid crystal element 104b by the application of the voltage Vd. Since the polarization direction of the incident laser beam is angularly displaced with respect to the reference polarization direction of the S-polarization liquid crystal element 104b by 90 degrees, there is no likelihood that the incident laser beam is subjected to diffraction by the S-polarization liquid crystal element 104b, even if the voltage is not applied to the S-polarization liquid crystal element 104b.

Thus, the incident laser beam is transmitted through the switching mirror 104, and is guided to the mirror 105.

On the other hand, the reflected laser beam (S-polarized laser beam) reflected by the disc is, as shown in FIG. 4B, first inputted to the S-polarization liquid crystal element 104b. In this condition, a Bragg grating fringe (volume hologram structure) is not formed in the S-polarization liquid crystal element 104b, because the refractive indexes of the polymer and the crystal liquid in the S-polarization liquid crystal element 104b are identical to each other by the application of the voltage Vd. Accordingly, the reflected laser beam is transmitted through the S-polarization liquid crystal element 104b without being subjected to diffraction by the S-polarization liquid crystal element 104b.

Then, the reflected laser beam is inputted to the P-polarization liquid crystal element 104a. Similarly to the above, the reflected laser beam is transmitted through the P-polarization liquid crystal element 104a without being subjected to diffraction by the P-polarization liquid crystal element 104a, because a Bragg grating fringe (volume hologram structure) is not formed in the P-polarization liquid crystal element 104a by the application of the voltage Vd. Since the polarization direction of the reflected laser beam is angularly displaced with respect to the reference polarization direction of the P-polarization liquid crystal element 104a by 90 degrees, there is no likelihood that the incident laser beam is subjected to diffraction by the P-polarization liquid crystal element 104a, even if the voltage is not applied to the P-polarization liquid crystal element 104a.

Thus, the reflected laser beam is transmitted through the switching mirror 104, and is guided to the polarizing beam splitter 103.

As mentioned above, according to the embodiment, on-off control of the voltage to be applied to the P-polarization liquid crystal element 104a and to the S-polarization liquid crystal element 104b enables to properly switch over the input of the laser beam between the objective lenses 108 and 109. According to the embodiment, the electrically switchable Bragg-grating-based liquid crystal element can be used as a means for switching over the objective lenses, and simultaneously, the polarizing beam splitter 103 can be used as a means for changing over the optical paths for guiding the laser beam to the light detector 112.

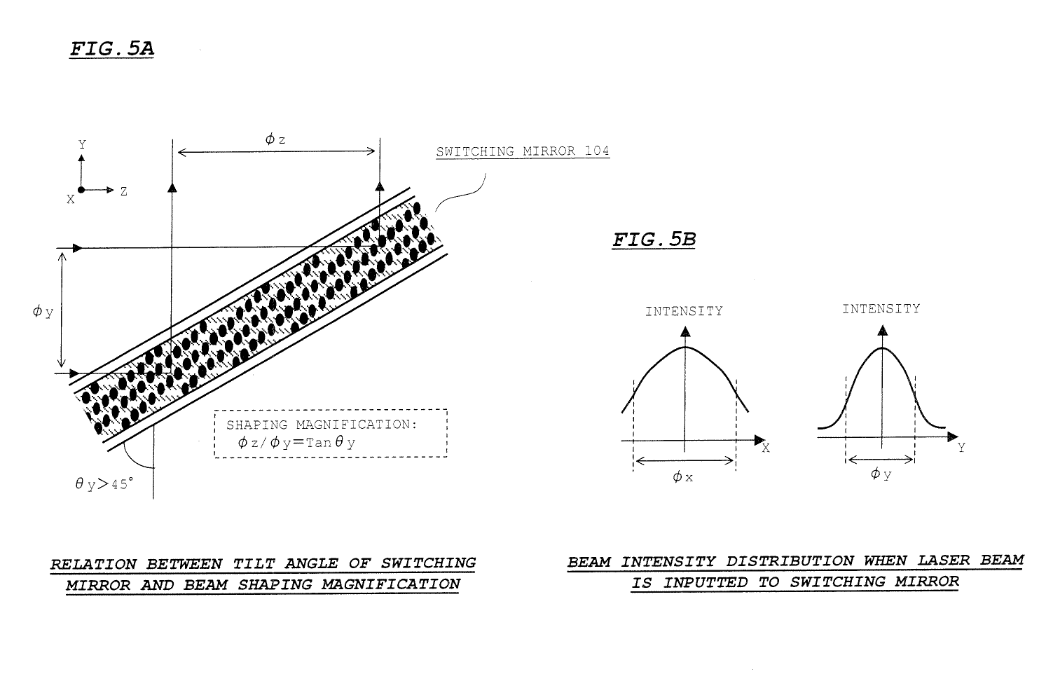

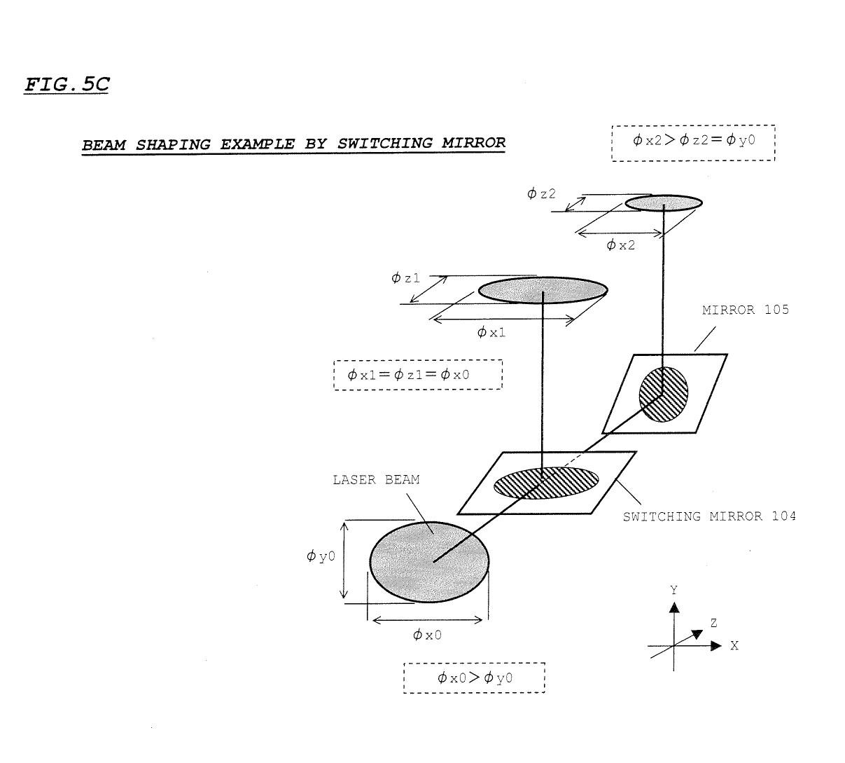

Next, a beam shaping effect by the switching mirror 104 is described referring to FIGS. 5A, 5B, and 5C.

As shown in FIG. 5A, a laser beam with a beam diameter By which has been incident onto the switching mirror 104 in the Z-axis direction is reflected by the switching mirror 104, whereby the laser beam is shaped into a laser beam with a beam diameter φz. Here, as shown in FIG. 5A, assuming that the tilt angle of the switching mirror 104 with respect to the Y-axis is θy, the shaping magnification of the beam spot before and after the reflection is expressed by: φz/φy=tan θy. If the tilt angle θy is 45°<θy<90°, the shaping magnification φz/φy is larger than 1. For instance, if the tilt angle θy=60°, the shaping magnification φz/φy=1.73.

Now, let it be assumed that a laser beam having an intensity distribution shown in FIG. 5B is inputted to the switching mirror 104 as shown in FIG. 5C. In such a case, in the embodiment, as described above, the tilt angle θy of the switching mirror 104 is larger than 45°. Accordingly, the shape of the laser beam after being reflected by the switching mirror 104 is expanded in a short axis direction thereof by φz/φy times. For instance, if the ratio of the beam diameters φy0 and φx0 of the laser beam before being inputted to the switching mirror 104 is φy0:φx0=1:1.73, and the tilt angle θy of the switching mirror 104 is θy=60°, the ratio of the beam diameters φx1 and φz1 of the laser beam after being reflected by the switching mirror 104 is φx1:φz1=1:1. This means that the shape of the reflected laser beam is a perfect circle.

In the embodiment, as shown in FIG. 5C, the laser beam is incident onto the switching mirror 104 in such a manner that the long axis and the short axis thereof are aligned with the X-axis direction and the Y-axis direction, respectively. Specifically, in the optical system shown in FIGS. 1A and 1B, the semiconductor laser 101 is arranged at such a position as to align the long axis of the beam shape in the X-axis direction. The alignment enables to change the shape of the laser beam after being reflected by the switching mirror 104 from an elliptical shape to a shape similar to a perfect circle.

In the embodiment, the mirror 105 is arranged with an inclination of 45° with respect to the Y-axis direction. Thereby, the shape of the laser beam after being reflected by the mirror 105 is identical to the shape of the laser beam before being inputted to the mirror 105 and to the switching mirror 104. In other words, there is no likelihood that the beam shaping effect is provided to the laser beam by the mirror 105.

As mentioned above, according to the embodiment, the shape of one of the two laser beams to be inputted to the objective lenses 108 and 109 i.e. the shape of the laser beam to be inputted to the objective lens 108 can be enlarged, as compared with the other one of the two laser beams. This enables to decrease the effective diameter of the objective lens 109, as compared with the effective diameter of the objective lens 108, thereby enabling to decrease the weight of the objective lens 109.

In the current technology, the objective lens for BD is heavy, as compared with the objective lens for HDDVD. This is because whereas the objective lens for HDDVD is made of a plastic material, the objective lens for BD is made of a glass material. Accordingly, as described in the embodiment, using the objective lens 108 for HDDVD and using the objective lens 109 for BD enables to reduce the weight of the objective lens for BD, which is generally heavy, as compared with the objective lens for HDDVD. Thereby, a weight difference between the objective lens for BD and the objective lens for HDDVD can be suppressed. This arrangement enables to secure a weight balance of the holder 107 on which the two objective lenses are held, and to stabilize the driving characteristics of the objective lenses by the objective lens actuator 110.

In the case where the two objective lenses are arranged in the optical system as shown in FIGS. 1A and 1B, the dimension of the optical system in the thickness direction (optical axis direction of the objective lens) is changed depending on the diameter of the laser beam immediately before being inputted to a rising mirror in inputting the laser beam to one of the two objective lenses having a larger aperture diameter, in other words, depending on the beam diameter φy0 shown in FIG. 5C. In other words, the thickness of the optical system can be decreased by decreasing the beam diameter φy0.

According to the embodiment, the short axis of the laser beam is expanded by the beam shaping effect by the switching mirror 104. Accordingly, even if the dimension of the laser beam in the short axis direction immediately before being inputted to the switching mirror 104, in other words, the beam diameter φy0 shown in FIG. 5C is significantly decreased, the laser beam is allowed to be inputted to the objective lens 108 with a sufficiently large effective diameter. Thus, the embodiment enables to input the laser beam to the objective lens 108 (for HDDVD) having a larger aperture diameter with a sufficiently large effective diameter, while suppressing increase of the beam diameter φy0, thereby enabling to decrease the dimension of the optical system in the thickness direction.

In the embodiment, a peripheral portion of the laser beam is blocked by a laser beam passing hole formed in the holder 107. Accordingly, the laser beam of a perfect circular shape is inputted to the objective lenses 108 and 109.

As mentioned above, according to the embodiment, on-off control of the voltage to be applied to the P-polarization liquid crystal element 104a and to the S-polarization liquid crystal element 104b enables to properly switch over the input of the laser beam between the objective lenses 108 and 109. Further, setting the tilt angle θy of the switching mirror 104 to more than 45° enables to decrease the thickness of the optical system and the weight of the objective lens 109 for BD.

The embodiment is not limited to the foregoing, but may be modified in various ways.

In the foregoing embodiment, the objective lens 108 is used for HDDVD, and the objective lens 109 is used for BD. Alternatively, the objective lens 108 may be used for BD, and the objective lens 109 may be used for HDDVD. In the modification, since the aperture diameter (effective diameter) of the objective lens 108 for BD can be increased, a working distance of the objective lens 108 in the focus direction can be increased. In the modification, since the weight difference between the objective lens 109 for HDDVD and the objective lens 108 for BD is increased, a means or an arrangement for securing a weight balance between the objective lenses 109 and 108 is required in the holder 107 or a like member.

In the foregoing embodiment, the blue wavelength laser beam is inputted to the objective lenses 108 and 109. The laser beam to be inputted to the objective lenses 108 and 109 is not limited to the above, but may be properly changed according to the specifications of the optical pickup device. In the modification, the objective lenses 108 and 109 are designed to properly converge the laser beam on a disc compatible with the optical pickup device.

For instance, in the case where the optical pickup device is compatible with BD, HDDVD, DVD (Digital Versatile Disc), and CD (Compact Disc), it is possible to provide the objective lens 108 for BD and the objective lens 109 for HDDVD, DVD, and CD.

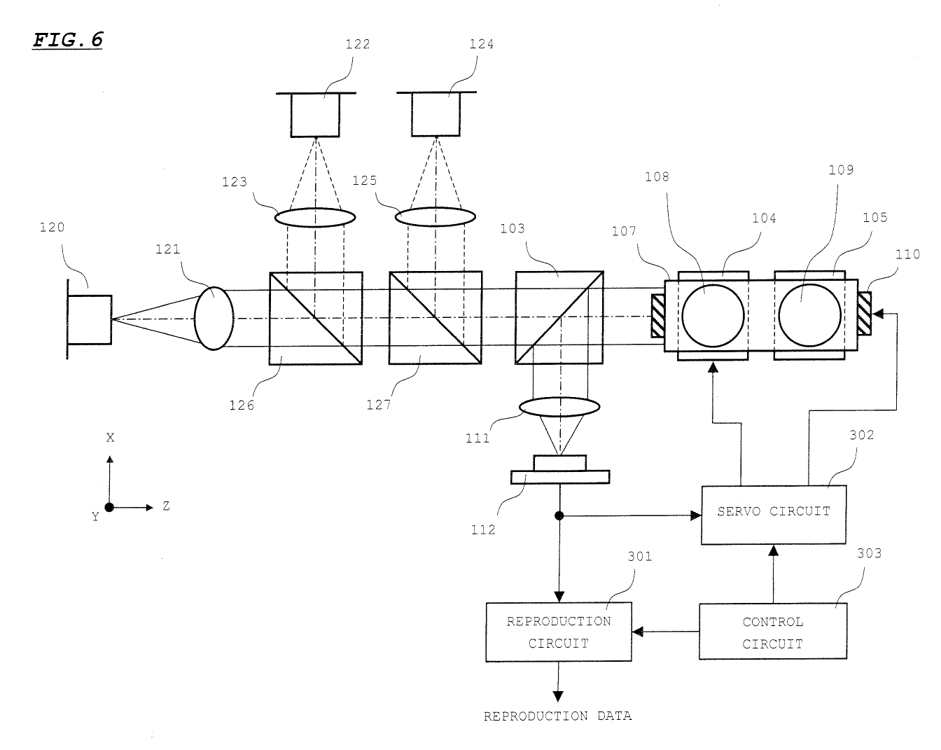

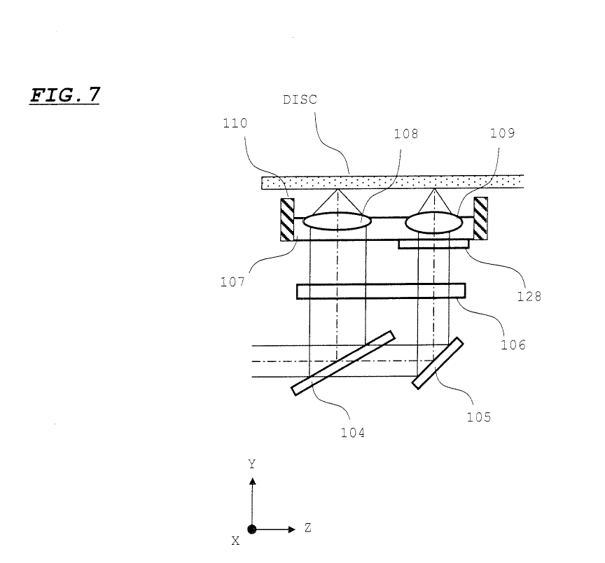

FIGS. 6 and 7 are diagrams showing an example of an optical system of the optical pickup device compatible with BD, HDDVD, DVD, and CD. FIG. 6 is a top plan view of the optical system, and FIG. 7 is a side view showing an objective lens actuator and peripheral parts thereof. The elements of the optical system shown in FIGS. 6 and 7 which are identical or equivalent to those shown in FIGS. 1A and 1B are denoted with the same reference numerals.

Referring to FIGS. 6 and 7, the reference numeral 120 denotes a semiconductor laser for outputting laser beams (for CD) having a wavelength of about 780 nm corresponding to red. 121 denotes a collimator lens for collimating the laser beams outputted from the semiconductor laser 120 into parallel beams. 122 denotes a semiconductor laser for outputting laser beams (for DVD) having a wavelength of about 650 nm corresponding to red. 123 denotes a collimator lens for collimating the laser beams outputted from the semiconductor laser 122 into parallel beams. 124 denotes a semiconductor laser for outputting laser beams (for BD and HDDVD) having a wavelength of about 400 nm corresponding to blue. 125 denotes a collimator lens for collimating the laser beams outputted from the semiconductor laser 124 into parallel beams.

The reference numeral 126 denotes a dichroic prism for transmitting the laser beams coming from the collimator lens 121, and for reflecting the laser beams coming from the collimator lens 123. 127 denotes a dichroic prism for transmitting the laser beams coming from the dichroic prism 126, and for reflecting the laser beams coming from the collimator lens 125.

The reference numeral 128 denotes an aperture restricting element for restricting the aperture diameter exclusively for an infrared wavelength laser beam (for CD). A film coated element may be used as the aperture restricting element 128. The film coated element is formed by coating a film pattern having a wavelength selectivity at a position where an outer peripheral portion of the infrared wavelength laser beam is inputted. The outer peripheral portion of the infrared wavelength laser beam is exclusively reflected, using the reflection by the film pattern.

In the above arrangement, the objective lens 108 is used for BD, and the objective lens 109 is used for HDDVD, DVD, and CD.

In use of the optical system shown in FIGS. 6 and 7, in the case where recording/reproduction is performed with respect to BD, the semiconductor laser 124 is turned on, and the voltage to be applied to the P-polarization liquid crystal element 104a and to the S-polarization liquid crystal element 104b in the switching mirror 104 is turned off (applied voltage=0). In the case where recording/reproduction is performed with respect to HDDVD, the semiconductor laser 124 is turned on, and the voltage to be applied to the P-polarization liquid crystal element 104a and to the S-polarization liquid crystal element 104b in the switching mirror 104 is turned on (applied voltage=Vd).

In the case where recording/reproduction is performed with respect to CD or DVD, the semiconductor laser 120 or 122 is turned on, and the voltage to be applied to the P-polarization liquid crystal element 104a and to the S-polarization liquid crystal element 104b in the switching mirror 104 is turned on (applied voltage=Vd).

Generally, the Bragg grating fringe (volume hologram structure) has a high polarization dependency and a high wavelength selectivity. Accordingly, the laser beam whose polarization direction and wavelength are different from those of the laser beam used in fixation of the polymer is allowed to be transmitted, without being subjected to diffraction. Therefore, in the case where the laser beam for CD or DVD is used, it is conceived that the laser beam is not greatly affected by diffraction by the P-polarization liquid crystal element 104a and the S-polarization liquid crystal element 104b, even if the voltage Vd is not applied to the P-polarization liquid crystal element 104a and to the S-polarization liquid crystal element 104b in the switching mirror 104.

In the case where the laser beam for CD or DVD is not greatly affected by the Bragg grating fringe (volume hologram structure), the voltage to be applied to the P-polarization liquid crystal element 104a and to the S-polarization liquid crystal element 104b may be turned off (applied voltage=-) in use of the laser beam for CD or DVD. If, however, in the case where the laser beam for CD or DVD is subjected to an unwanted diffraction by the Bragg grating fringe (volume hologram structure), it is desirable to apply the voltage to the P-polarization liquid crystal element 104a and to the S-polarization liquid crystal element 104b (applied voltage=Vd).

In the above arrangement, the voltage Vd to be applied in transmitting the laser beam for HDDVD, the voltage Vd to be applied in transmitting the laser beam for DVD, and the voltage Vd to be applied in transmitting the laser beam for CD may be different from each other.

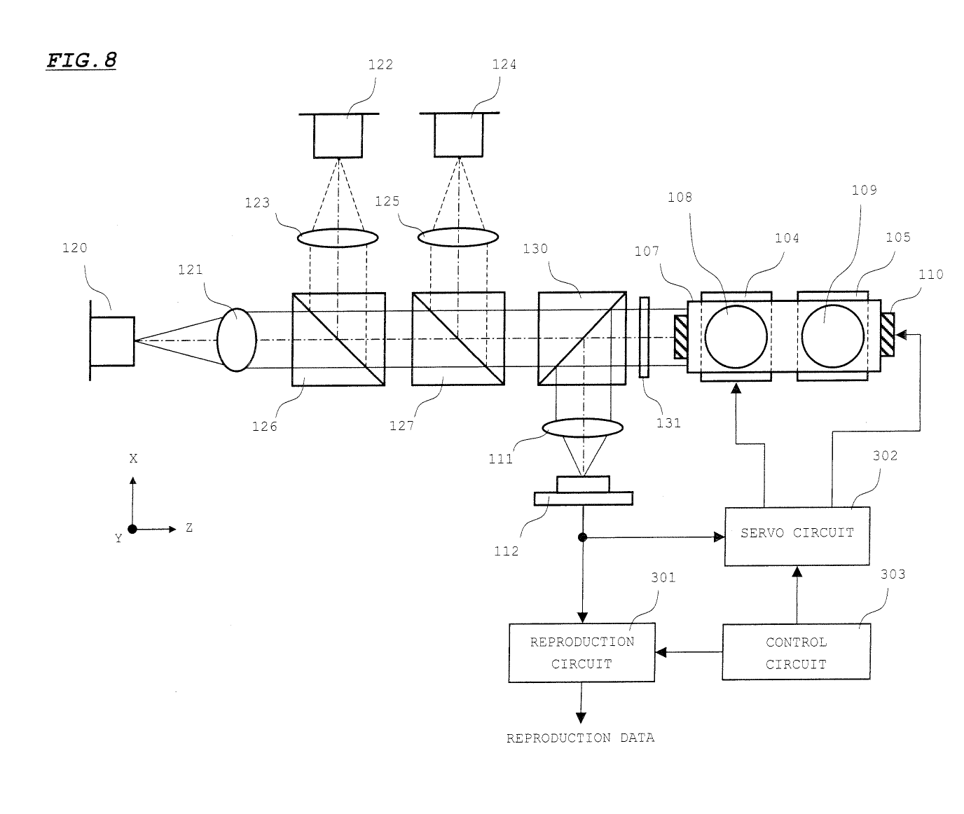

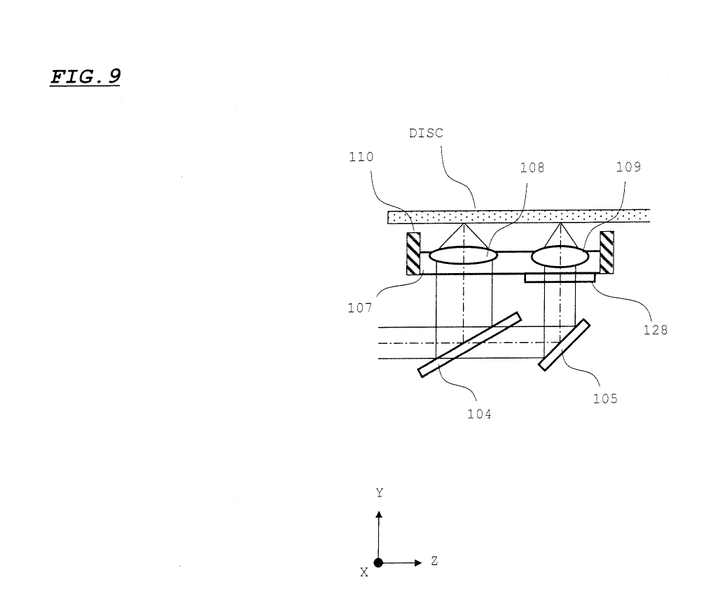

In view of the above, the optical system shown in FIGS. 6 and 7 may be further modified into an optical system shown in FIGS. 8 and 9. The modified optical system shown in FIGS. 8 and 9 is different from the optical system shown in FIGS. 6 and 7 in that the polarizing beam splitter 103 is replaced by an HM/PBS (half-mirror/polarizing-beam-splitter) unit 130. Also, the λ/4 plate 106 in FIGS. 6 and 7 is omitted, and a λ/4 plate 131 is provided immediately after the HM/PBS unit 130.

Similarly to the arrangement shown in FIGS. 6 and 7, the HM/PBS unit 130 serves as a polarizing beam splitter with respect to a red wavelength laser beam and an infrared wavelength laser beam, and serves as a half mirror with respect to a blue wavelength laser beam.

Similarly to the λ/4 plate 106 shown in FIGS. 6 and 7, the λ/4 plate 131 angularly displaces the polarization direction of the red wavelength laser beam and the infrared wavelength laser beam, but does not angularly displace the polarization direction of the blue wavelength laser beam.

The modified optical system shown in FIGS. 8 and 9 is different from the optical system shown in FIGS. 6 and 7 in that the polarization direction of the blue laser beam to be inputted to the disc is coincident with the polarization direction of the blue laser beam reflected by the disc. This enables to construct the switching mirror 104 merely of the P-polarization liquid crystal element 104a.

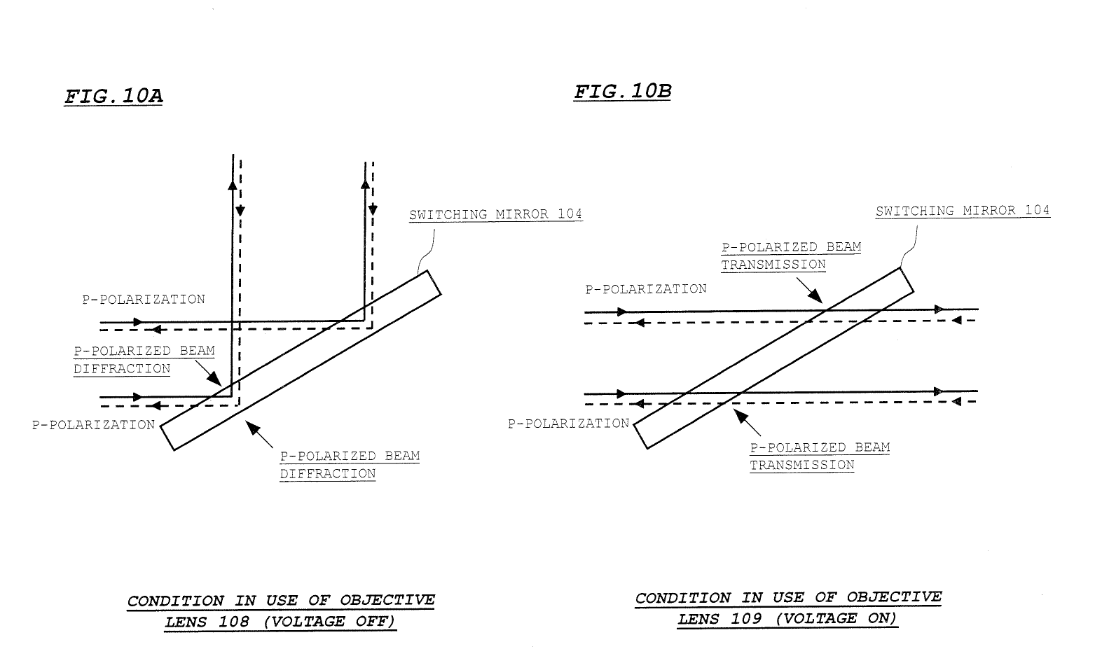

FIGS. 10A and 10B show an optical path switching operation to be executed in the case where the switching mirror 104 is constituted merely of the P-polarization liquid crystal element 104a.

In the case where the blue laser beam is inputted to the objective lens 108 (for BD), the semiconductor laser 124 is turned on, and the voltage to be applied to the switching mirror 104 (P-polarization liquid crystal element 104a) is turned off (applied voltage=0). Thereby, as shown in FIG. 10A, the blue laser beam from the semiconductor laser 124 is reflected by the switching mirror 104, and is guided to the objective lens 108 (for BD). Also, the reflection beam from the disc is reflected by the switching mirror 104, and is guided to the HM/PBS unit 130.

In the case where the blue laser beam is inputted to the objective lens 109 (for CD, DVD, or HDDVD), the semiconductor laser 124 is turned on, and the voltage to be applied to the switching mirror 104 (P-polarization liquid crystal element 104a) is turned on (applied voltage=Vd). Thereby, as shown in FIG. 10B, the blue laser beam from the semiconductor laser 124 is transmitted through the switching mirror 104, and is guided to the objective lens 109 (for CD, DVD, or HDDVD). Also, the reflection beam from the disc is transmitted through the switching mirror 104, and is guided to the HM/PBS unit 130.

In the case where the red laser beam or the infrared laser beam is inputted to the objective lens 109 (for CD, DVD or HDDVD), the semiconductor laser 120 or 122 is turned on, and the voltage to be applied to the switching mirror 104 (P-polarization liquid crystal element 104a) is turned on (applied voltage=Vd). Thereby, the laser beam from the semiconductor laser 120 or 122 is transmitted through the switching mirror 104, and is guided to the objective lens 109 (for CD, DVD, or HDDVD). Also, the reflection beam from the disc is transmitted through the switching mirror 104, and is guided to the HM/PBS unit 130.

In the optical system shown in FIGS. 8 and 9, the HM/PBS unit 130 is provided in place of the polarizing beam splitter. Accordingly, as compared with the arrangement shown in FIGS. 6 and 7, the usability of the blue laser beam is decreased. However, a λ/4 plate is not provided between the objective lenses 108 and 109, and the switching mirror 104 and the mirror 105. Accordingly, as compared with the arrangement shown in FIGS. 6 and 7, the dimension of the optical system in the thickness direction can be further decreased.

The foregoing embodiment has been described as above, but the invention is not limited to the foregoing.

In the arrangement shown in FIGS. 6 and 7, the semiconductor lasers 120, 122, and 124 are arranged individually with respect to the wavelengths, and the optical axes of the laser beams having the respective wavelengths are aligned by the dichroic prisms 126 and 127. Alternatively, an optical system may be configured by using a semiconductor laser for outputting a plurality of kinds of laser beams of different wavelengths from a common casing member in the identical directions to each other.

In the modification, the semiconductor laser 101 shown in FIGS. 1A and 1B is replaced by a three-wavelength semiconductor laser for outputting laser beams of three different wavelengths. Also, the collimator lens 102 is replaced by a collimator lens for collimating each of the laser beams of the three wavelengths into parallel beams. The collimator lens may be formed by attaching plural lens elements whose Abbe number and curvature (spherical surface) are adjusted to provide e.g. an achromatic effect with respect to the laser beams of the three wavelengths.

In the case where the three-wavelength semiconductor laser is used, a displacement may occur between the optical axes of the laser beams due to an arrangement displacement of the laser elements for outputting laser beams of the respective wavelengths. In view of this, in the above modified arrangement, it is desirable to provide an optical axis correcting element for correcting the optical axis displacement of the laser beams e.g. immediately after the collimator lens. The optical axis correcting element may be constituted of e.g. a diffraction grating. In the modification, a diffraction pattern having a wavelength selectivity is formed on the optical axis correcting element. The optical axis correcting element aligns the optical axis of a laser beam having a predetermined wavelength among the laser beams to be outputted from the three-wavelength semiconductor laser with the optical axes of the laser beams having the wavelengths other than the predetermined wavelength by diffraction.

In the embodiment, the switching mirror 104 is constructed in such a manner that the Bragg grating fringe (volume hologram structure) is formed when the applied voltage is turned off, and the Bragg grating fringe (volume hologram structure) is not formed when the applied voltage is turned on. Alternatively, the switching mirror 104 may be constructed in such a manner that the Bragg grating fringe (volume hologram structure) is formed when the applied voltage is turned on, and the Bragg grating fringe (volume hologram structure) is not formed when the applied voltage is turned off. In the modification, the refractive index np of the polymer and the refractive index nLC of the liquid crystal in the P-polarization liquid crystal element 104a and the S-polarization liquid crystal element 104b are adjusted to satisfy the relation: nLC=np in a condition that a voltage is not applied to the polymer dispersed liquid crystal 201.

In the embodiment, the two objective lenses are used. Alternatively, the invention may be applicable to an arrangement that three or more objective lenses are used. For instance, in use of three objective lenses, a switching mirror may be additionally provided between the switching mirror 104 and the mirror 105, and an objective lens may be additionally provided at the position corresponding to the added switching mirror.

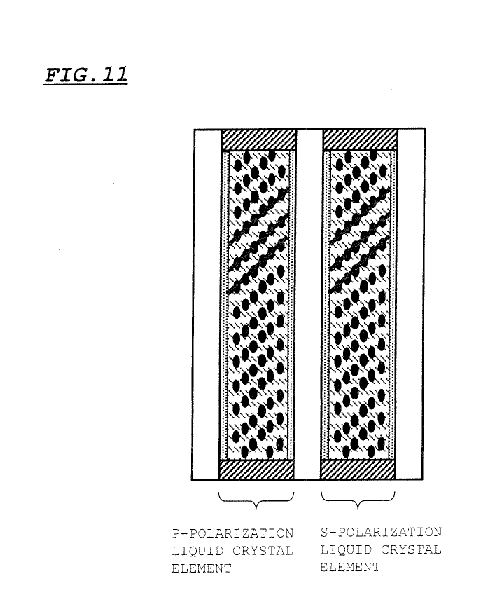

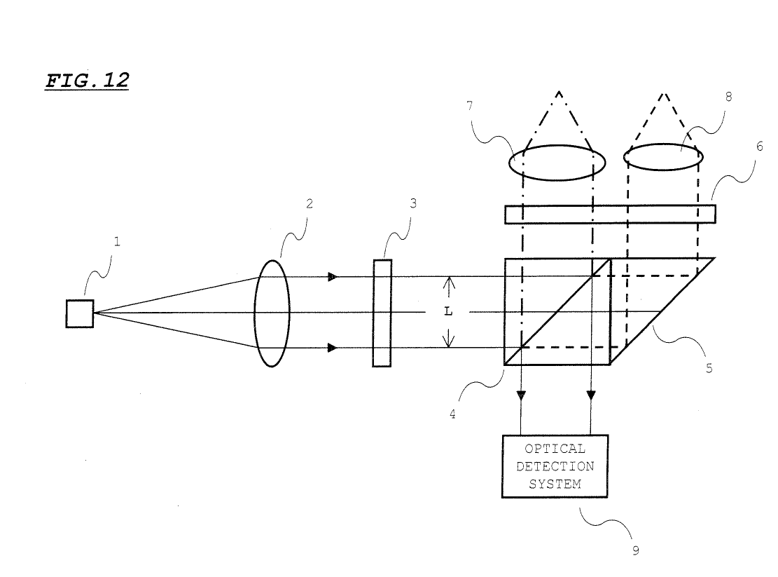

In the embodiment, as shown in FIG. 2B, the switching mirror 104 functioning in two polarization directions is constructed by individually preparing the two switching mirror components each functioning in one polarization direction, and by attaching the two switching mirror components via the adhesive layer 205. Alternatively, as shown in FIG. 11, an arrangement without an adhesive layer may be provided. Such an arrangement may be constructed by e.g. fixedly forming a P-polarization liquid crystal layer by P-polarization on a liquid crystal element, followed by fixedly forming an S-polarization liquid crystal layer on the P-polarization liquid crystal layer by S-polarization.

The embodiment of the invention may be properly modified in various ways as far as such modifications do not depart from the scope of the technical idea of the invention defined in the claims.

What is claimed is:

1. An optical pickup device, comprising:
a first objective lens;
a Bragg-grating-based liquid crystal element disposed on an optical axis of the first objective lens with a tilt angle of more than 45° with respect to the optical axis of the first objective lens, the Bragg-grating-based liquid crystal element being so configured that a laser beam is inputted in a first direction perpendicular to the optical axis of the first objective lens, and that the laser beam is transmitted or reflected in a second direction parallel to the optical axis of the first objective lens depending on application and non-application of a voltage;
a second objective lens disposed away from the first objective lens in the first direction, and having an optical axis parallel to the optical axis of the first objective lens; and
an optical element for guiding the laser beam transmitted through the Bragg-grating-based liquid crystal element to the second objective lens, wherein
a short axis direction of a shape of the laser beam to be inputted to the Bragg-grating-based liquid crystal element is parallel to the second direction.

2. The optical pickup device according to claim 1, further comprising:
a light source for outputting a plurality of kinds of laser beams of different wavelengths, and
an optical system for inputting the laser beams from the light source to the Bragg-grating-based liquid crystal element, wherein
the Bragg-grating-based liquid crystal element is so configured as to exhibit a diffraction reflection with respect to a laser beam having a predetermined wavelength among the plurality of kinds of inputted laser beams.

3. The optical pickup device according to claim 1, wherein
the optical element is a mirror disposed on the optical axis of the second objective lens with a tilt angle of 45° with respect to the optical axis of the second objective lens, the optical element reflecting in the second direction the laser beam transmitted through the Bragg-grating-based liquid crystal element.

4. The optical pickup device according to claim 3, further comprising:
a light source for outputting a plurality of kinds of laser beams of different wavelengths, and
an optical system for inputting the laser beams from the light source to the Bragg-grating-based liquid crystal element, wherein
the Bragg-grating-based liquid crystal element is so configured as to exhibit a diffraction reflection with respect to a laser beam having a predetermined wavelength among the plurality of kinds of inputted laser beams.

5. The optical pickup device according to claim 4, wherein
the light source includes a plurality of semiconductor lasers for outputting a plurality of kinds of laser beams of different wavelengths, and
the optical system includes an optical path regulating element for collecting optical paths of the laser beams to be outputted from the semiconductor lasers into a single optical path to input the laser beams along the single optical path to the Bragg-grating-based liquid crystal element.

6. The optical pickup device according to claim 1, wherein
the Bragg-grating-based liquid crystal element is disposed with such a tilt angle with respect to the optical axis of the first objective lens that a shape of the laser beam after being reflected is formed into a substantially perfect circle.

7. The optical pickup device according to claim 1, wherein
a λ/4 plate is arranged between the first objective lens and the Bragg-grating-based liquid crystal element, and
the Bragg-grating-based liquid crystal element includes:
a first Bragg-grating-based liquid crystal element which exhibits a diffraction reflection with respect to the laser beam before a linear polarization direction of the laser beam is angularly displaced by the λ/4 plate; and
a second Bragg-grating-based liquid crystal element which exhibits a diffraction reflection with respect to the laser beam after the linear polarization direction of the laser beam is angularly displaced by the λ/4 plate.
